(19) United States
(12) Patent Application Publication
(10) Pub. No.: US 2009/0320640 A1
(43) Pub. Date: Dec. 31, 2009

(54) Variable inertia flywheel

(76) Inventors: Christopher Mark Elliott, Apex, NC (US); Brian Mintah, Washington, IL (US); David Alan Lapen, Peoria, IL (US)

Correspondence Address: CATERPILLAR/FINNEGAN, HENDERSON, L.L.P., 901 New York Avenue, NW, WASHINGTON, DC, 20001-4413, US

(21) Appl. No.: 12/216,123

(22) Filed: Jun. 30, 2008

(51) Int. Cl. F16F 15/31

(52) U.S. Cl. 74/572.21

(57) ABSTRACT

A variable inertia flywheel includes a generally circular body coupled to a shaft, and a cavity positioned radially on the body. The flywheel may also include a mass configured to translate radially in the cavity and form an inner chamber proximate a center of the body and an outer chamber distal to the center of the body. The flywheel may further include a conduit fluidly coupling a hydraulic fluid to the outer chamber, and a control valve coupled to the conduit and configured to direct the fluid to the outer chamber.

### TECHNICAL FIELD

The present disclosure relates generally to a flywheel of an engine, and more particularly, to a variable inertia flywheel.

### BACKGROUND

An internal combustion engine produces power by converting the pressure of combustion gases, formed by the combustion of a fuel in one or more cavities, to rotational torque of a crankshaft. Since combustion in each cavity occurs once per rotation of the crankshaft, the output torque of the crankshaft (engine torque) may be periodic over time. In order to reduce pulsations of engine torque, a flywheel may typically be coupled to the crankshaft between the engine and the transmission. A flywheel is a rotating disc used as a storage device for kinetic energy. Flywheels resist changes in their rotational speed due to inertia. This inertia of the flywheel helps to steady the rotation of the crankshaft when a periodic torque is exerted on it by the engine. The flywheel absorbs excess energy when engine torque is momentarily larger than that needed to service the load on the transmission, and releases energy when there is a momentary increase in load which requires more power than that produced by the engine. Absorption and release of energy by the flywheel help prevent the fluctuation of engine speed in response to momentary changes in load.

The kinetic energy of a flywheel rotating about a central axis can be expressed as E_{f}=½ I ω², where E_{f} is the kinetic energy of the flywheel, I is the moment of inertia of the flywheel, and ω is the angular velocity of the flywheel about the axis of rotation, expressed in rad/s (1 rad/s=9.55 r/min (rpm)). The kinetic energy of a flywheel increases linearly with moment of inertia. Moment of inertia describes the ability of the flywheel to resist changes in its angular velocity. The moment of inertia is expressed as I=k m r², where k is a constant that depends on the shape of the flywheel, m is the mass of flywheel, and r is the distance of the mass from the axis of rotation of the flywheel. As the mass of a flywheel is increased, its moment of inertia, and hence the kinetic energy stored therein, increases. Conversely, as the mass of the flywheel decreases, its moment of inertia decreases, and engine torque output may become unstable. When the mass of the flywheel is increased, the torque output of the engine stabilizes. However, the acceleration characteristics of the engine deteriorate with increasing flywheel mass. For a flywheel of constant mass, the greater the distance of the mass from the axis of rotation (that is, increasing r), the greater is the moment of inertia of the flywheel. Conversely, the lower the distance of the mass from the axis of rotation, the lower is the moment of inertia of the flywheel.

To accommodate the changing moment of inertia requirements of the flywheel at different engine operating conditions, a variable moment of inertia flywheel may be used. Korean Publicly Opened Patent Publication No. KR20020054011 published by Ju Yeon Ho on Jul. 6, 2002 (the '011 publication) describes such a variable inertia flywheel. In the flywheel of the '011 publication, spring loaded movable masses are arranged around the axis of rotation. To increase the moment of inertia of the flywheel of the '011 publication, oil under pressure is injected into the center of the flywheel to push the movable masses outwards. When oil pressure on the inward side of the masses decreases below the spring force on the outward side, the masses are pushed by the springs towards the center of the flywheel. In the flywheel of the '011 publication, oil pressure pushes the masses outwards to increase the moment of inertia, and the spring force pushes the masses inwards to decrease the moment of inertia of the flywheel. Although the variable moment of inertia flywheel of the '011 publication may vary the moment of inertia of the flywheel in response to changing engine operating conditions, it may have disadvantages. For instance, relying solely on mechanical springs to push the masses inwards may introduce reliability issues due to variations in spring forces.

The disclosed variable inertia flywheel is directed at overcoming shortcomings as discussed above and/or other shortcomings in existing technology.

### SUMMARY

In one aspect, a variable inertia flywheel is disclosed. The flywheel may include a generally circular body coupled to a shaft, and a cavity positioned radially on the body. The flywheel may also include a mass configured to translate radially in the cavity and form an inner chamber proximate a center of the body and an outer chamber distal to the center of the body. The flywheel may further include a conduit fluidly coupling a hydraulic fluid to the outer chamber, and a control valve coupled to the conduit and configured to direct the fluid to the outer chamber.

In another aspect, a method of operating a variable inertia flywheel coupled to a shaft of an engine is disclosed. The flywheel may include an elongate cavity positioned radially on the flywheel. The flywheel may also include a mass configured to translate radially in the cavity to form an inner chamber proximate the shaft and an outer chamber distal to the shaft. The method may include accelerating the engine, and allowing the mass to move radially outwards at least partly due to the acceleration. The method may also include directing a hydraulic fluid through a conduit to the outer chamber to push the mass radially inwards.

In yet another aspect, a machine is disclosed. The machine may include an engine configured to rotate a shaft about an axis of rotation, and wheels coupled to the engine through the shaft. The machine may also include a variable inertia flywheel coupled to the shaft. The flywheel may include a plurality of elongated cavities disposed symmetrically about the axis of rotation. Each elongated cavity may include a mass movable between an inner position and an outer position. The inner position may be a position proximate the axis of rotation, and the outer position may be a position distal to the axis of rotation. Each elongated cavity may also include an inner chamber, where the inner chamber is a space in the elongated cavity inwards of the mass, and an outer chamber, where the outer chamber is a space in the elongated cavity outwards of the mass. The flywheel may also include a conduit configured to direct a hydraulic fluid to the outer chamber to move the mass towards the inner position.

### BRIEF DESCRIPTION OF THE DRAWINGS

FIG. 1 is an illustration of an exemplary machine including a variable inertia flywheel;

FIG. 2 is a schematic illustration of an embodiment of the variable inertia flywheel of FIG. 1;

FIG. 3 is a schematic illustration of another embodiment of the variable inertia flywheel of FIG.1; and

FIG. 4 is a flowchart illustrating an exemplary operation of the flywheel of FIG. 2.

### DETAILED DESCRIPTION

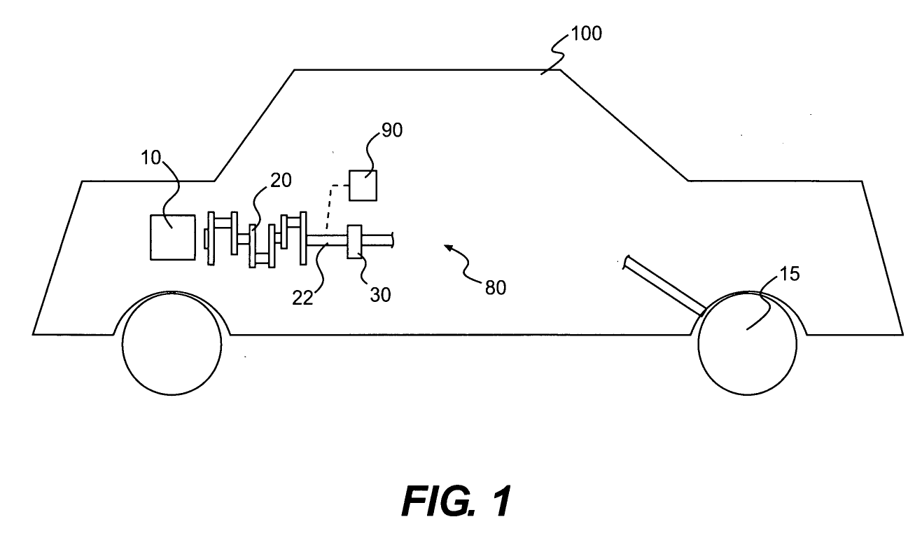

FIG. 1 illustrates an exemplary machine 100. Machine 100 may include an engine 10 operably coupled to wheels 15 through a transmission 80. Engine 10 may include a crank shaft 20 that converts reciprocating motion of pistons (not shown) of engine 10 to rotary motion of shaft 22. Coupled to shaft 22 may be a variable moment of inertia (variable inertia) flywheel 30. Flywheel 30 may act as a mechanical battery to smooth the torque output of engine 10. That is, due to discrete power strokes of engine 10, the torque output of engine 10 may fluctuate depending upon the angular position of crank shaft 20. Flywheel 30 may absorb excess energy when the torque produced by engine 10 is momentarily larger than that needed by machine 100, and releases energy when engine output torque momentarily decreases. Machine 100 may also include a control unit 90 (such as an electronic control unit ECU) that may, among others, control the configuration of flywheel 30. Machine 100 may include other systems and devices that are not illustrated in FIG. 1, as only those systems and devices that are useful in describing the flywheel of the current disclosure are described herein.

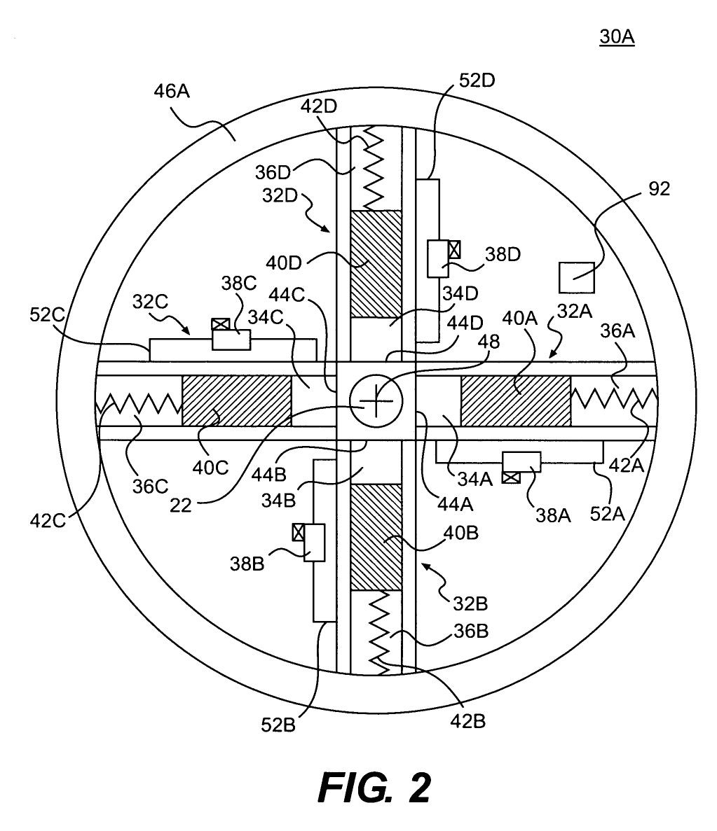

FIG. 2 is a schematic illustration of an embodiment of a variable inertia flywheel 30A of the current disclosure. Flywheel 30A may include a substantially circular disk 46A coupled to shaft 22 of engine 10. Although FIG. 2 illustrates flywheel 30A as disk shaped, it is contemplated that flywheel 30A can have other shapes and configurations. For instance, flywheel 30A may include an outer rim connected to a central rim or hub using one or more spokes. Flywheel 30A may be made of any material known in the art.

Embedded (or coupled) to flywheel 30A may be a plurality of elongate cavities (or cylinders) 32A, 32B, 32C, and 32D symmetrically positioned about an axis of rotation 48 of flywheel 30A. Some embodiments of flywheels of the current disclosure may have an even number of cavities. In these embodiments, each cavity of a pair of cavities may be disposed substantially opposite the other cavity of the pair. Embodiments of flywheels with an odd number of cavities are also contemplated. In these embodiments, the odd number of cavities may be symmetrically disposed about axis of rotation 48. Cavities 32A, 32B, 32C, and 32D may include movable masses 40A, 40B, 40C, and 40D that are configured to translate radially from an inner position proximate the axis of rotation 48 to an outer position distal to the axis of rotation 48. The translating masses 40A-40D may form two chambers, an inner chamber 34A, 34B, 34C, and 34D, and an outer chamber 36A, 36B, 36C, and 36D, in a space between each mass and the corresponding cavity. The inner chambers 34A, 34B, 34C, and 34D may be formed on the inward side of the masses 40A-40D, and the outer chambers 36A, 36B, 36C, and 36D may be formed on the outward side of the masses 40A-40D. In the inner position, the masses 40A-40D may rest against, or proximate, stops 44A, 44B, 44C, and 44D. In this position, the masses 40A-40D may occupy substantially the entire space of inner chamber 34A-34D. Included in outer chamber 36A-36D may be spring members 42A,42B, 42C, and 42D that may apply a force on masses 40A-40D. The spring force may tend to push masses 40A-40D towards the inner position. When the masses 40A-40D move towards the outer position, the spring members may compress and apply an inward force (force towards inner position) on masses 40A-40D.

Pipe or conduit 52A may fluidly couple inner chamber 34A to outer chamber 36A. Similarly, pipes or conduits 52B, 52C, and 52D may fluidly couple inner chambers 34B, 34C, and 34D to outer chambers 36B, 36C, and 36D, respectively. Conduits 52A, 52B, 52C, and 52D may contain a hydraulic fluid, and may include control valves 38A, 38B, 38C, and 38D, respectively. These control valves may be switchable between an open and a closed position. In the open position, hydraulic fluid may be transferred between inner chamber 34A-34D and outer chamber 36A-36D. In the closed position, inner chamber 34A-34D may be isolated from outer chamber 36A-36D, and no fluid transfer between the two chambers may occur. In the closed position, hydraulic fluid may be trapped in one or both of inner chamber 34A-34D and outer chamber 36A-36D.

When control valves 38A-38D are in the closed position, the hydraulic fluid trapped in inner chamber 34A-34D and outer chamber 36A-36D may lock masses 40A-40D in position and prevent further movement of masses 40A-40D. In this configuration, the force exerted on the inward side of masses 40A-40D may be equal to the force exerted on the outward side of masses 40A-40D. When flywheel 30A is stationary, the force exerted on the inward side of masses 40A-40D may be the pressure of the hydraulic fluid trapped in inner chamber 34A-34D, and the force exerted on the outward side may be equal to the sum of the force due to the hydraulic fluid in the outer chamber 36A-36D and the force of spring members 42A-42D. When flywheel 30A is accelerating, centrifugal force may tend to move masses 40A-40D to the outer position. If control valves 38A-38D are in the closed position, the hydraulic fluid trapped in inner chambers 34A-34D and outer chambers 36A-36D may keep the masses locked and substantially prevent masses 40A-40D from moving. When masses 40A-40D are locked, flywheel 30A may have a fixed moment of inertia that depends upon the radial distance of the locked masses 40A-40D from the axis of rotation 48.

If control valves 38A-38D are in the open position, hydraulic fluid from outer chambers 36A-36D may be forced into inner chambers 34A-34D as centrifugal forces move the masses 40A-40D towards the outer position when flywheel 30A is accelerating. When flywheel 30A decelerates, hydraulic fluid may move from the inner chambers 34A-34D to outer chambers 36A-36D as spring forces push the masses 40A-40D towards the inner position.

Control valves 38A-38D may be switched between open and closed positions wirelessly. Wireless signals from control unit 90 (seen in FIG. 1) may switch control valves 38A-38D between open and closed positions. In some embodiments, control unit 90 may simultaneously switch all control valves 38A-38D to an open or a closed position. However, in other embodiments, control unit 90 may only activate selected control valves 38A-38D. Although each control valve may be individually switched between an open and a closed position, typically, for balanced rotation of flywheel 30A, control valves of a pair of opposing cavities may be simultaneously switched to an open or a closed position. It is also contemplated that, in some embodiments, control valves 38A-38D may be electrically coupled to control unit 90 using a wired network. Although any suitable control valve may be used as control valves 38A-38D, in some embodiments, these control valves may be of an electromechanical or a hydro-mechanical type.

Flywheel 30A may also include an embedded processor 92 that controls the actuation of control valves 38A-38D. Power for operation of processor 92 and the control valves 38A-38D may be provided by methods well known in the art. For instance, brushes that contact electrical contacts on the rotating flywheel 30A may provide power to the flywheel from a power source (such as, a battery) of machine 100 (see FIG. 1). Power may also be provided to rotating flywheel 30A by a battery embedded in the flywheel. This embedded battery may be recharged electro-magnetically. For instance, flywheel 30A may include a coil that rotates, along with flywheel 30A, in a magnetic field. The electromagnetic current thus induced in the coil may be used to charge the battery, or provide power to processor 92 and control valves 38A-38D. In some embodiments, processor 92 may obtain data from control unit 90 (see FIG. 1) wirelessly. This data may include signals indicating load and acceleration requirements of machine 100. Feedback of the positions of masses 40A-40D may also be input into processor 92. Based on the data input into processor 92, processor 92 may activate control valves 38A-38D to vary the moment of inertia of flywheel 30A based on the operating requirements of machine 100.

Although in the embodiment of flywheel 30A depicted in FIG. 2 the masses 40A-40D are pushed from the inner position to the outer position (when control valves 38A-38D are open) by centrifugal force when flywheel 30A is accelerating, and the masses 40A-40D are pushed from the outer position to the inner position by force of the spring members 42A-42D, other configurations are possible. For instance, in some embodiments, a pump may be embedded in flywheel 30A to pump the hydraulic fluid to outer chambers 36A-36D or inner chambers 34A-34D to move masses inwards or outwards when desired. In such an embodiment, hydraulic fluid may be pumped to inner chambers 34A-34D to push masses 40A-40D outwards even when the masses are decelerating (that is, in the absence of centrifugal force to push the masses 40A-40D outwards). Any suitable type of pump may be embedded in flywheel 30A to pump the hydraulic fluid between inner chambers 34A-34D and outer chambers 36A-36D. In some embodiments, the embedded pump may include a gear pump. This gear pump may include a rotating gear in flywheel 30A meshing with a stationary gear located external to flywheel 30A.

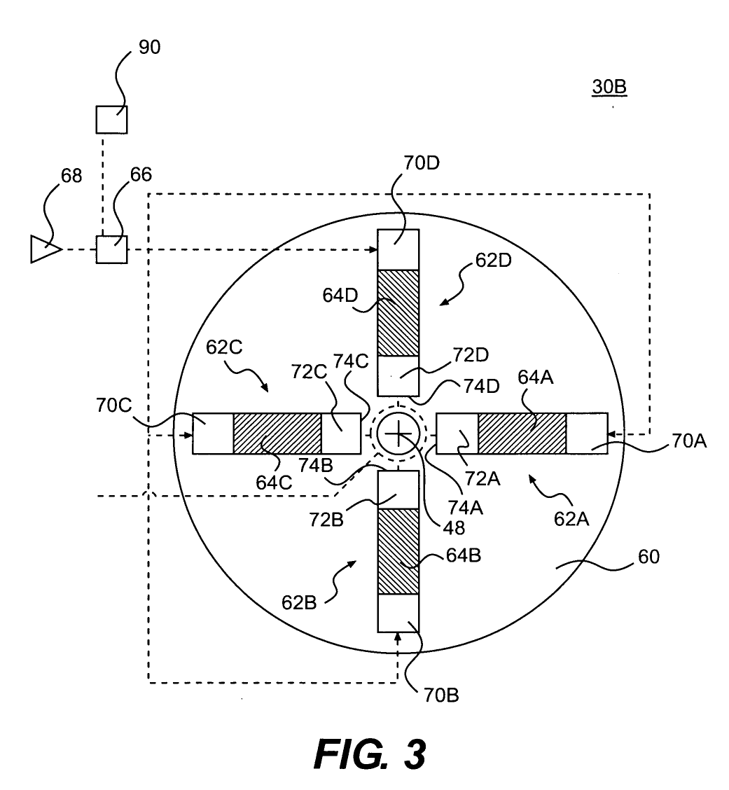

In some embodiments, hydraulic fluid may be pumped from an external source to one or more of inner chambers 34A-34D and outer chambers 36A-36D to push masses 40A-40D to the inner and outer positions. Such an embodiment may be desirable when there is an excess supply of high pressure hydraulic fluid (such as, oil) that may be used to drive masses 40A-40D inwards or outwards. FIG. 3 shows a schematic of an embodiment of flywheel 30B in which a high pressure hydraulic fluid from an external source 68 (or reservoir) may be used to move masses 64A-64D.

Flywheel 30B of FIG. 3 may include a substantially circular disk 60 coupled to shaft 22 of engine 10. Although FIG. 3 illustrates flywheel 30B as disk shaped as in flywheel 30A of FIG. 2, flywheel 30B also may have other configurations. Flywheel 30B may have a plurality of elongate cylinders or cavities 62A-62D disposed symmetrically about axis of rotation 48 of flywheel 30B. As described with reference to FIG. 2, although flywheel 30B may include any number of cavities, some embodiments of flywheel 30B may have an even number of cavities, with each cavity of a pair of cavities disposed substantially opposite the other cavity of the pair. Cavities 62A-62D may include masses 64A-64D configured to move from an inner position proximate axis of rotation 48 to an outer position distal from axis of rotation 48. Cavities 62A-62D may form an inner chambers 72A-72D on the inward side of masses 64A-64D, and outer chambers 70A-70D on the outward side of masses 64A-64D.

Hydraulic fluid from an external source 68 (external to flywheel 30B) may be pumped to outer chambers 70A-70D to move masses 64A-64D towards the inner position. Any external source of hydraulic fluid may be used to provide hydraulic fluid to flywheel 30B. In machines with Hystat transmissions, high pressure oil from the Hystat system may be used as hydraulic fluid. Based on instructions from control unit 90, a control valve 66 may deliver the hydraulic fluid to outer chambers 70A-70D. The hydraulic fluid on outer chambers 70A-70D may push masses 64A-64D towards inner position, and lower the moment of inertia of flywheel 30B. In some embodiments, a spring member (similar to spring members 42A-42D of flywheel 30A shown in FIG. 2) may also be included in outer chambers 70A-70D to assist in pushing masses 64A-64D towards inner position. Cavities 62A-62D may also include an orifice 74A-74D on the inner position. Hydraulic fluid that may have leaked into inner chambers 72A-72D may be drained through orifices 74A-74D as masses 64A-64D move towards the inner position. This drained oil may be fed back into the hydraulic system or may be discarded.

As engine 10 accelerates, the centrifugal force on masses 64A-64D may move masses 64A-64D towards the outer position. When it is desired to lower the moment of inertia of flywheel 30B, hydraulic fluid from external source 68 may be delivered to outer chamber 70A-70D to move masses 64A-64D towards the inner position. Although not illustrated for the sake of clarity, the hydraulic circuits of FIG. 2 and FIG. 3 may include other hydraulic devices that may assist in the performance of flywheels 30A and 30B. For instance, a pump may be included in the system to increase the pressure of fluid being delivered to outer chamber 70A-70D. There may also be a variety of design and control configurations that may be employed with flywheels 30A and 30B depending upon the application.

### INDUSTRIAL APPLICABILITY

The disclosed variable inertia flywheels may be applied to any application where it is desirable to vary the moment of inertia of the flywheel in response to changing operating conditions of the engine. Movable masses coupled to the flywheel may be moved by the pressure of a hydraulic fluid to vary the moment of inertia of the flywheel. By moving the masses to different distances from the axis of rotation, and selectively moving some of the masses, a wide variation in moment of inertia may be possible. Using the pressure of a hydraulic fluid to move the masses may enable the flywheel to respond quickly to changing operating conditions. Additionally, different configurations of the hydraulic system may be possible to suit different applications. For instance, in applications where it is desirable to avoid delivering fluid to a rotating flywheel from an external source, an embodiment where the fluid is contained substantially within the flywheel may be utilized. Similarly, in applications, where it is desirable to move the masses without relying on centrifugal force to assist in the movement, fluid under pressure may be used to assist in translation of the masses. The operation of a variable inertia flywheel will now be described.

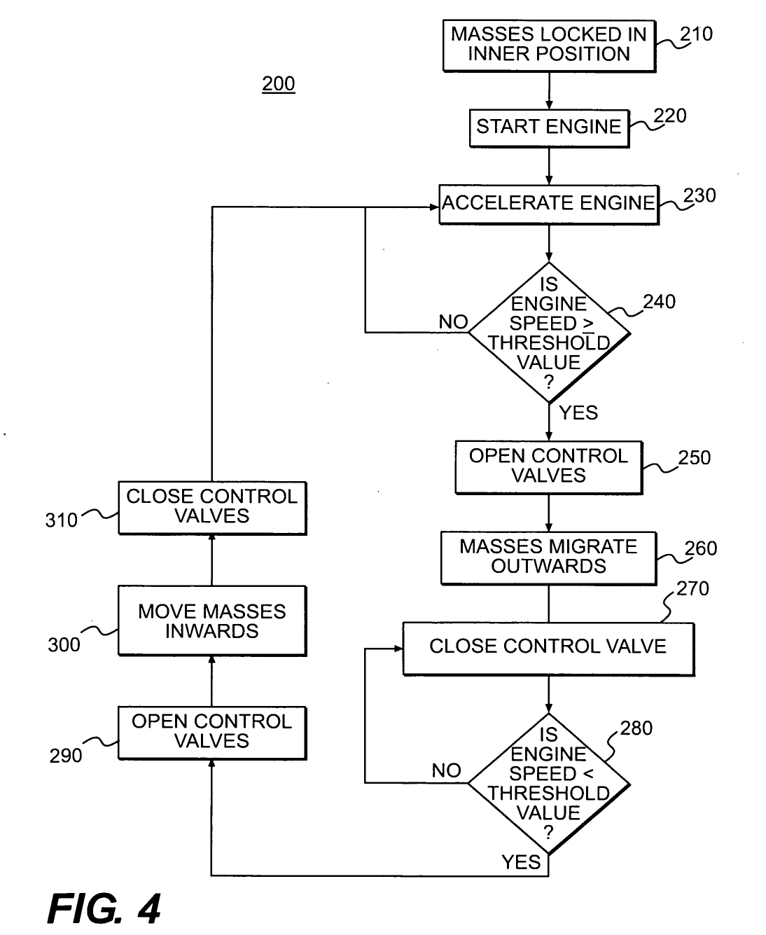

To illustrate the operation of a variable inertia flywheel of the current disclosure, the embodiment of flywheel 30A depicted in FIG. 2 coupled to machine 100 of FIG. 1 will be used. FIG. 4 is a flow chart that illustrates a method of operation. It should be understood that different embodiments of flywheels of the current disclosure may require modifications to the method of operation described herein. At the start of engine 10 (FIG. 1), masses 40A-40D may be locked in the inner position (step 210). In this configuration, the moment of inertia of flywheel 30A may be a minimum value. As engine 10 is started and accelerated (steps 220 and 230), the low moment of inertia of flywheel 30A may make it less resistant to changes in angular velocity, thereby, improving the acceleration response of engine 10. Processor 92 or control unit 90 may compare an angular velocity (or acceleration) of flywheel 30A to a threshold value of angular velocity (step 240). If the angular velocity is greater than or equal to the threshold value, control valves 38A-38D may be opened (step 250) to allow hydraulic fluid to move from outer chambers 36A-36D to inner chambers. If the angular velocity is less than the threshold value, the engine may be operated with the control valves 38A-38D in their preexisting position. If control valves 38A-38D are opened, as a result of the angular velocity of flywheel 30A being greater than or equal to the threshold value, hydraulic fluid moves from the outer chambers 36A-36D to the inner chambers 34A-34D, and masses 40A-40D migrate outwards. The moment of inertia, and hence the kinetic energy stored in flywheel 30A, increases. Some or all of control valves 38A-38D may then be closed to maintain the moment of inertia of flywheel 30A (step 270). When flywheel 30A has a high moment of inertia, acceleration response of engine 10 may be poor. However, the high moment of inertia of flywheel 30A may smooth variations in engine torque due to abrupt changes in load and produce a smooth engine torque output. As engine 10 decelerates, the angular velocity of engine correspondingly decreases. The processor 92 or control unit 90 may again compare the angular velocity to a threshold value (step 280). If the angular velocity is below the threshold value, control valves 38A-38D may be opened (step 290). If the angular velocity of flywheel 30A is not below the threshold value, control valves 38A-38D may remain closed. If control valves 38A-38D are opened, spring members 42A-42D may force masses 40A-40D towards the inner position (step 300). As masses 40A-40D move towards the inner position, the hydraulic fluid in inner chambers 34A-34D may move to outer chambers 36A-36D. Control valves 38A-38D may then be closed to lock masses 40A-40D in the inner position (step 310). Moving the masses 40A-40D to the inner position may lower the moment of inertia of flywheel 30A, and hence may allow engine 10 to recover quickly.

Moving the hydraulic fluid between inner chambers 34A-34D and outer chambers 36A-36D may allow the hydraulic fluid to be substantially contained within flywheel 30A, thereby eliminating the need for an external supply of hydraulic fluid. Avoiding delivering fluid to a rotating flywheel may simplify the design by eliminating the need for leak-proof seals. In embodiments of flywheels having an embedded processor to actuate the control valves, and an electromagnetic power supply to power the processor, electrical contacts to transfer electrical signals to the rotating flywheel may also be eliminated.

It will be apparent to those skilled in the art that various modifications and variations can be made to the disclosed variable inertia flywheel. Other embodiments will be apparent to those skilled in the art from consideration of the specification and practice of the disclosed variable inertia flywheel. It is intended that the specification and examples be considered as exemplary only, with a true scope being indicated by the following claims and their equivalents.

What is claimed is:

1. A variable inertia flywheel comprising:
a generally circular body coupled to a shaft, the body including a cavity positioned radially on the body;
a mass configured to translate radially in the cavity and form an inner chamber proximate a center of the body and an outer chamber distal to the center of the body;
a conduit fluidly coupling a hydraulic fluid to the outer chamber; and
a control valve coupled to the conduit and configured to direct the fluid to the outer chamber.

2. The flywheel of claim 1, wherein the conduit fluidly couples the inner chamber to the outer chamber.

3. The flywheel of claim 2, wherein an open position of the control valve allows the hydraulic fluid to flow between the inner chamber and the outer chamber.

4. The flywheel of claim 1, wherein the hydraulic fluid is contained substantially within the flywheel.

5. The flywheel of claim 1, further including a processor coupled to the flywheel, the processor configured to activate the control valve in response to signals from a control unit.

6. The flywheel of claim 5, wherein electrical power to the processor is provided electromagnetically when the flywheel rotates.

7. The flywheel of claim 5, wherein the control unit is wirelessly coupled with the processor.

8. The flywheel of claim 1 further including a spring member in the outer chamber of the cavity, the spring member being configured to assist in moving the mass towards the center of the body.

9. The flywheel of claim 1, wherein the cavity includes a plurality of cavities positioned symmetrically about an axis of rotation of the flywheel, and the mass includes a plurality of masses, each mass of the plurality being configured to translate radially in a cavity of the plurality.

10. The flywheel of claim 1, wherein the conduit directs hydraulic fluid from a reservoir positioned outside the flywheel to the outer chamber.

11. The flywheel of claim 10, wherein the reservoir includes pressurized hydraulic fluid.

12. The flywheel of claim 1, wherein the cavity includes an orifice configured to drain hydraulic fluid from the inner chamber.

13. A method of operating a variable inertia flywheel coupled to a shaft of an engine, the flywheel including an elongate cavity positioned radially on the flywheel and a mass configured to translate radially in the cavity to form an inner chamber proximate the shaft and an outer chamber distal to the shaft, comprising:
accelerating the engine;
allowing the mass to move radially outwards at least partly due to the acceleration; and
directing a hydraulic fluid through a conduit to the outer chamber to push the mass radially inwards.

14. The method of claim 13, further including opening a control valve coupled to the conduit to allow the mass to move radially outwards, wherein opening the control valve directs hydraulic fluid from the outer chamber to the inner chamber.

15. The method of claim 13, wherein directing the hydraulic fluid includes directing the hydraulic fluid from a reservoir located outside the flywheel.

16. The method of claim 13, wherein directing the hydraulic fluid includes directing the hydraulic fluid from the inner chamber to the outer chamber.

17. The method of claim 13, further including closing a control valve to lock the mass in place within the cavity.

18. A machine comprising:
an engine configured to rotate a shaft about an axis of rotation;
wheels coupled to the engine through the shaft;
a variable inertia flywheel coupled to the shaft, the flywheel including,
a plurality of elongated cavities disposed symmetrically about the axis of rotation, each elongated cavity of the plurality including,
a mass movable between an inner position and an outer position, the inner position being a position proximate the axis of rotation and the outer position being a position distal to the axis of rotation,
an inner chamber, the inner chamber being a space in the elongated cavity inwards of the mass,
an outer chamber, the outer chamber being a space in the elongated cavity outwards of the mass, and
a conduit configured to direct a hydraulic fluid to the outer chamber to move the mass towards the inner position.

19. The machine of claim 18, further including a spring member, the spring member being configured to assist in moving the mass from the outer position to the inner position.

20. The machine of claim 18, further including a control valve coupled to the conduit, the control valve being configured to be operable in response to an operating condition of the engine.
